(19) United States
(12) Patent Application Publication
(10) Pub. No.: US 2017/0367370 A1
(43) Pub. Date: Dec. 28, 2017

(54) Freezing Cylinder Beater

(71) Applicant: Carrier Corporation, Jupiter, FL (US)

(72) Inventors: Robert E. Frisque, Milton, WI (US); Stephen M Wadle, Beloit, WI (US)

(73) Assignee: Carrier Corporation, Jupiter, FL (US)

(21) Appl. No.: 15/525,437

(22) PCT Filed: Dec. 10, 2015
(86) PCT No.: PCT/US2015/064940

§ 371 Date: May 9, 2017

Related U.S. Application Data
(60) Provisional application No. 62/095,882, filed on Dec. 23, 2014.

(51) Int. Cl. A23G 9/28; A23G 9/12; B01F 7/08

(52) U.S. Cl. CPC A23G 9/28; A23G 9/12; B01F 7/088

(57) ABSTRACT

A frozen product dispensing apparatus (20) comprises a refrigeration system (50) and a freezing cylinder (52). A source (42) of the product or precursors of the product is coupled to an inlet (124) of the freezing cylinder. An outlet valve (38) has an open condition for discharging product from the freezing cylinder. A beater assembly (53) is within the freezing cylinder and has an axis (502) and an outer helical member (152). A motor (62) is coupled to the beater assembly for driving rotation of the beater assembly about the axis so that when driving said rotation in a first direction (530), the outer helical member drives product (540) toward the outlet valve. The beater further comprises an inner helical member (200; 300; 400) within the outer helical member.

### CROSS-REFERENCE TO RELATED APPLICATION

Benefit is claimed of U.S. Patent Application No. 62/095,882, filed Dec. 23, 2014, and entitled “Freezing Cylinder Beater”, the disclosure of which is incorporated by reference herein in its entirety as if set forth at length.

### BACKGROUND

The disclosure relates to dispensing of frozen confectionary products such as soft-serve ice cream, ice milk, frozen yogurt, artificial substitutes therefor, and the like. More particularly, the disclosure relates to dispensing valves for dispensers of such product.

Frozen confection dispensing systems are commonly used in the food service industry. An exemplary system configuration comprises a cabinet containing a mixing vessel (e.g., hopper) for mixing the confection. From the mixing vessel, the confection passes to a freezing vessel (e.g., a freezing cylinder). An air pump may add air to the mix. A refrigeration system may refrigerate the confection in the mixing hopper and freeze the confection in the freezing cylinder (cooled to a frozen or semi-frozen state).

The cabinet may contain one or more stages of pumps for driving the confection from the vessel to a delivery head/valve assembly. An exemplary pump is positioned between the mixing upper and freezing cylinder, with a rotary action of a beater of the freezing cylinder acting as a further pump. An exemplary valve assembly is mounted on the front of the cabinet. The valve assembly typically has a downward-facing outlet for discharging the confection into a bowl, cup, cone, or the like. The valve may be manually-actuated (e.g., via a lever pivotable upward or downward about a transverse hinge axis from an off condition to a dispensing condition). The valve assembly body is often called a “door” mounted over a hole in the front face of the cabinet.

An exemplary beater comprises helical blade driven by a motor to rotate about an axis the rotation causes the blade to drive product toward an inlet port in the rear surface of the door. A fixed baffle may extend rearward from the door to prevent accumulation of a stagnant mass of product within the interior of the helix. Examples of such baffles and beaters are seen in U.S. Pat. No. 7,278,276 of Boyer et al., issued Oct. 9, 2007 and US Patent Application Publication 2013/0068331 of Matz et al., published Mar. 21, 2013.

### SUMMARY

One aspect of the disclosure involves a frozen product dispensing apparatus comprising a refrigeration system and a freezing cylinder. A source of the product or precursors of the product is coupled to an inlet of the freezing cylinder. An outlet valve has an open condition for discharging product from the freezing cylinder. A beater assembly is within the freezing cylinder and has an axis and an outer helical member. A motor is coupled to the beater assembly for driving rotation of the beater assembly about the axis so that when driving said rotation in a first direction, the outer helical member drives product toward the outlet valve. The beater further comprises an inner helical member within the outer helical member.

In one or more embodiments of any of the foregoing embodiments, the inner helical member has a spiral opposite to the outer helical member.

In one or more embodiments of any of the foregoing embodiments, the inner helical member is mounted to rotate as a unit with the outer helical member.

In one or more embodiments of any of the foregoing embodiments, the inner helical member has a spiral in the same direction as the outer helical member and the inner helical member is mounted to rotate opposite to rotation of the outer helical member.

In one or more embodiments of any of the foregoing embodiments, the inner helical member is mounted to remain stationary in operation.

In one or more embodiments of any of the foregoing embodiments, the outer helical member has a helix angle decreasing from a rear end toward a front end.

In one or more embodiments of any of the foregoing embodiments, the outer helical member is a blade integral to a frame having features for removably mounting wiper blades.

In one or more embodiments of any of the foregoing embodiments, the inner helical member has a blade integral to a shaft and an open cup at one end.

In one or more embodiments of any of the foregoing embodiments, the inner helical member, shaft, and open cup are a unitary non-metallic piece.

In one or more embodiments of any of the foregoing embodiments, the outlet valve comprises an outlet valve body. An axle has a first portion in threaded engagement with the outlet valve body and a second portion received in a compartment of the inner helical member.

In one or more embodiments of any of the foregoing embodiments, the beater assembly axis is within 10° of horizontal in a normal operational condition.

In one or more embodiments of any of the foregoing embodiments, wherein the outlet valve comprises: an inlet; an outlet; and a valve element. The valve element is shiftable between: a first condition providing communication between the inlet and the outlet; and a second condition blocking communication between the inlet and the outlet.

In one or more embodiments of any of the foregoing embodiments, an actuator is coupled to the valve element and manually engagable by a user to shift the valve element between the first condition and the second condition.

In one or more embodiments of any of the foregoing embodiments, the actuator comprises a lever, the lever being shiftable from a neutral condition to respective first and second lever conditions to, respectively, shift the valve element to the valve element's first and second conditions.

In one or more embodiments of any of the foregoing embodiments, a cabinet has a front, wherein the source is within the cabinet and the valve is mounted on the front.

In one or more embodiments of any of the foregoing embodiments, the apparatus is in combination with the confectionary product, the confectionary product being a frozen confectionary product.

In one or more embodiments of any of the foregoing embodiments, a method for operating the apparatus comprises: running the motor to drive said rotation in said first direction so that the outer helical member drives the product toward the outlet valve and the inner helical member drives product away from the outlet valve.

In one or more embodiments of any of the foregoing embodiments, the method further comprises opening the outlet valve from a closed condition to the open condition so as to discharge product from the freezing cylinder.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a front view of a soft-serve freezer.

FIG. 2 is a right side view of the freezer of FIG. 1.

FIG. 3 is an isolated vertical/axial sectional view of a subassembly of freezing cylinder, beater/scraper, valve, and transmission.

FIG. 3A is an enlarged view of a forward end of the subassembly of FIG. 3.

FIG. 4 is a view of the forward end of FIG. 3A in a discharging condition.

FIG. 5 is a view of the subassembly of FIG. 3 absent the freezing cylinder.

FIG. 6 is a first view of a central beater helical member (screw) of the combination of FIG. 3.

FIG. 7 is a second view of the beater screw of FIG. 6.

FIG. 8 is an isolated vertical/axial sectional view of a second subassembly of freezing cylinder, beater/scraper, valve, and transmission.

FIG. 9 is an isolated vertical/axial sectional view of a third subassembly of freezing cylinder, beater/scraper, valve, and transmission.

Like reference numbers and designations in the various drawings indicate like elements.

### DETAILED DESCRIPTION

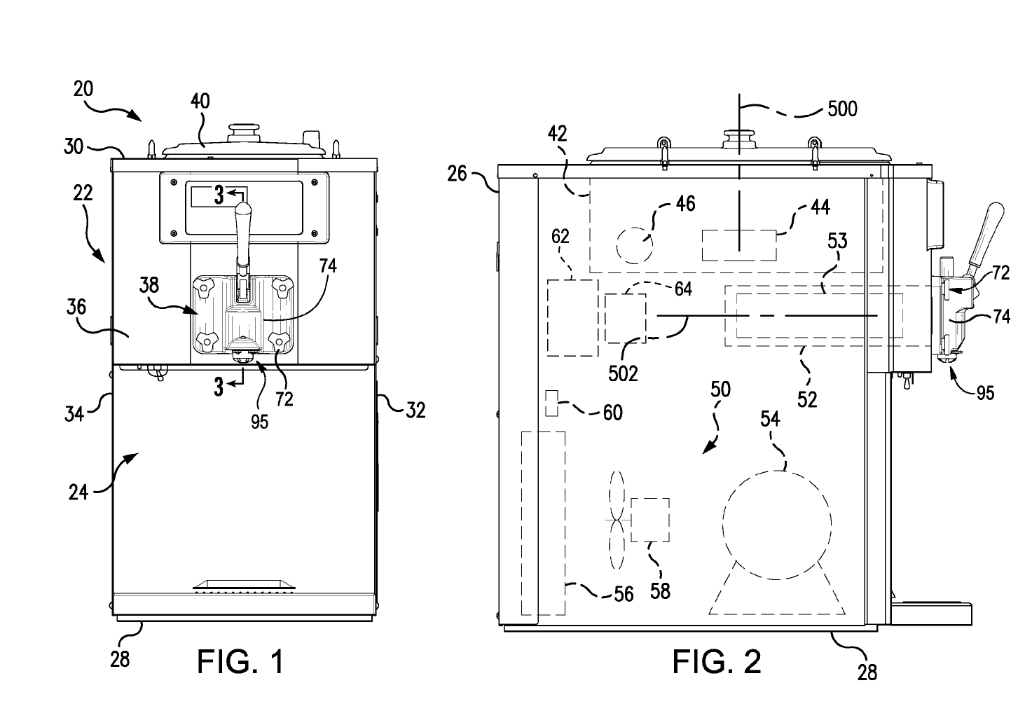

FIGS. 1&2 show a soft-serve freezer 20 which is formed as a modification of an existing model C708 Soft-Serve Freezer of Taylor Company (a division of Carrier Commercial Refrigeration, Inc.) of Rockton, Ill. However, other freezers may be similarly modified (including other general configurations and multi-flavor or other variations on the illustrated or other configuration). The freezer comprises a cabinet 22 having a front 24, a back 26, a base or bottom 28, a top 30, and respective left and right sides 32 and 34. An upper portion of the cabinet front is formed by a panel 36 to which a dispensing valve assembly 38 is mounted. The exemplary top includes a removable cover/lid 40. The lid 40 covers a mixing hopper 42 for receiving and mixing the confection or its ingredients (e.g., having an agitator 44 (driven for rotation about an axis 500) and having an air injection pump 46).

A refrigeration system 50 (e.g., a vapor compression-expansion cycle) is provided to refrigerate the confection in the hopper. A freezing cylinder 52 is located between the hopper 42 and the valve assembly 38. The freezing cylinder contains a beater assembly (beater/scraper assembly) 53 (driven for rotation about an axis 502). The axis 502 is generally horizontal (e.g., within 10° of horizontal in a normal operating condition, more particularly within 5°). The refrigeration system includes appropriate heat absorption heat exchangers to cool the hopper 42 and freezing cylinder 52 to appropriate temperatures and maintain those temperatures. The heat absorption heat exchangers (which absorb heat in the normal mode (as distinguished from defrost mode, cleaning mode, or pasteurization mode)) may be integrated with the hopper 42 and cylinder 52. A compressor of the refrigeration system is schematically shown as 54, a normal mode heat rejection heat exchanger (e.g., condenser) as 56, its associated fan as 58, and an expansion device as 60. Also schematically shown are an electric motor 62 and a transmission 64 for driving the rotation of the beater assembly.

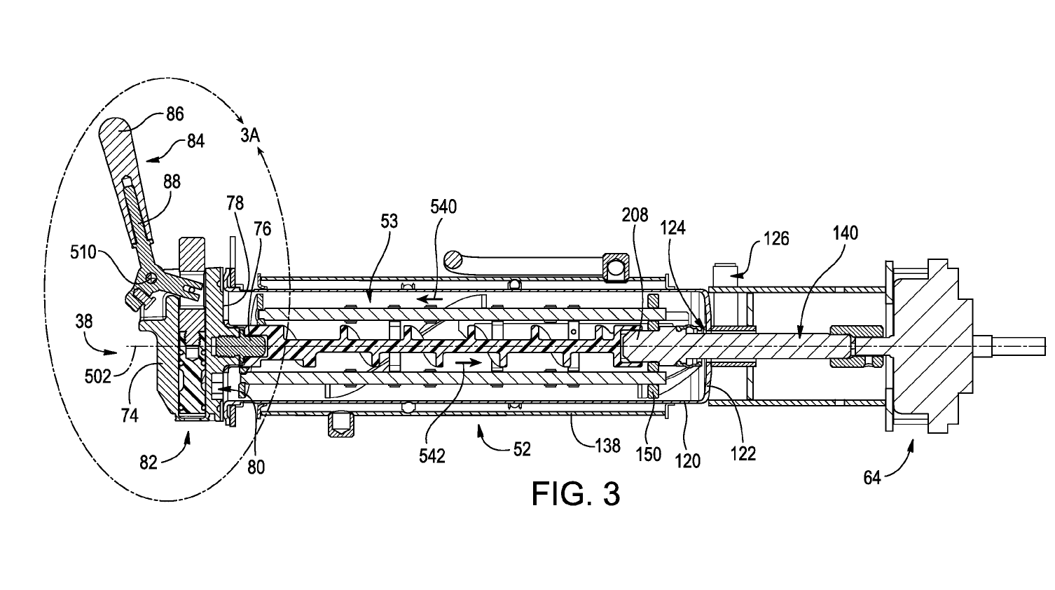

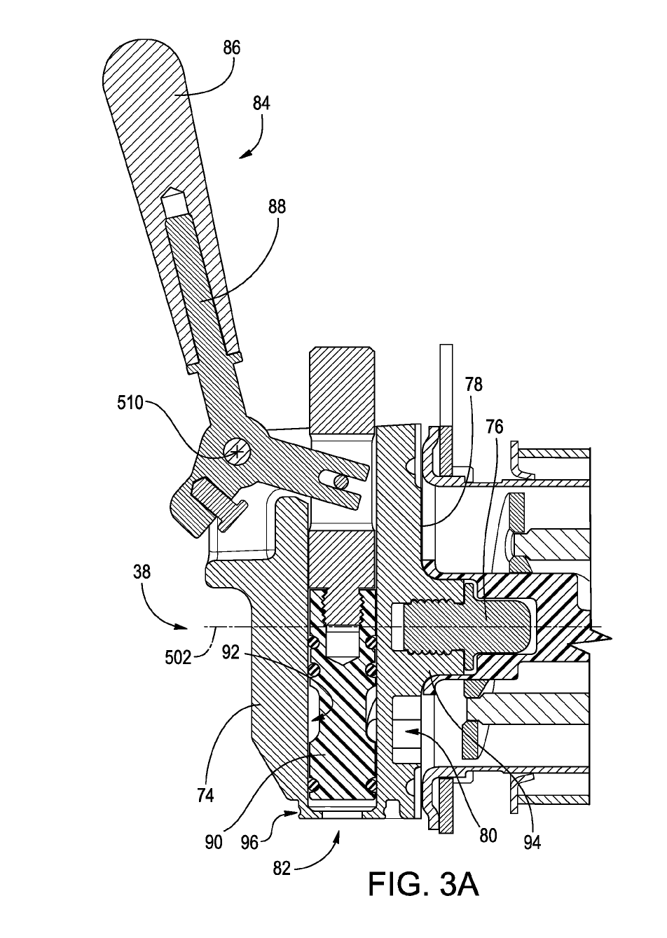

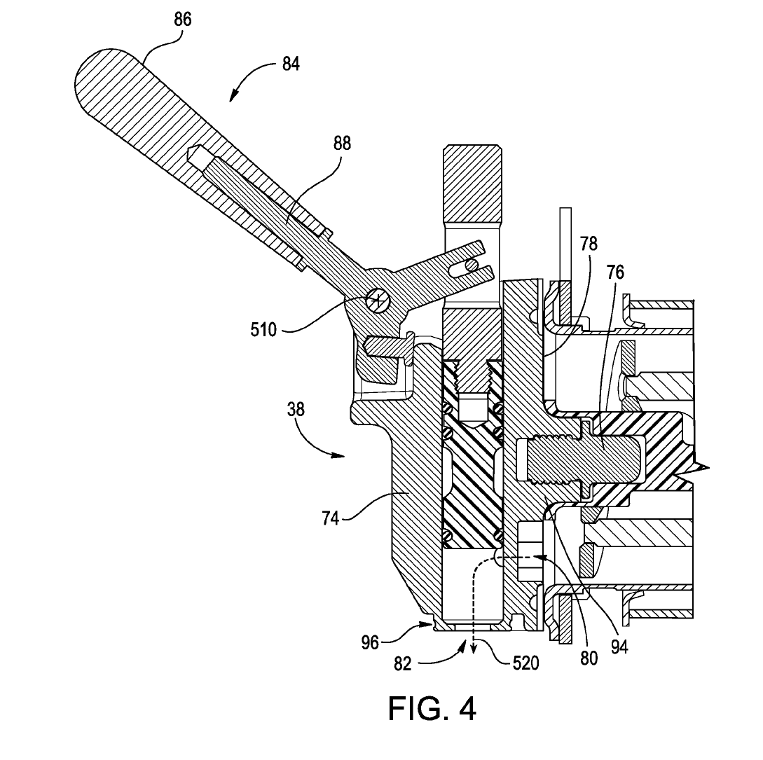

FIG. 3 is an isolated vertical/axial sectional view of the valve assembly 38, freezing cylinder 52, beater assembly 53, and transmission 64. FIG. 4 is a view of a combination of the valve assembly 38, beater assembly 53, and transmission 64.

The exemplary valve assembly 38 serves as a door which closes the downstream end of the freezing cylinder. The exemplary valve assembly 38 is mounted via hand-actuated screws 72 (FIG. 1) to permit removal and reinstallation for system cleaning. The valve assembly includes a door/valve body 74 (FIG. 3) which may be machined of an alloy (e.g., food-grade stainless steel) or molded of a food-grade plastic (e.g., polybutylene terephthalate (PBT)). In lieu of a prior art baffle assembly, an axle 76 extends from an aft face/surface 78 of the body 74. The door/valve body 74 includes an inlet 80 for receiving the confection from the freezing cylinder and an outlet 82 for dispensing the confection into bowls, cups, cones, and the like.

The exemplary valve assembly 38 is a manually-actuated valve which the user may actuate via rotating a lever 84 (e.g., via a handle 86 at a distal end of a lever arm (driving arm) 88) about a lever axis 510. The lever, in turn, controls movement of a piston-like valve member (element) 90 within a vertical bore (valve compartment) 92 of the valve body 64. FIG. 3A further shows the axle 76 mounted to a central boss 94 along the rear of the valve body 74. In the exemplary embodiment, the central boss 94 is threaded and, in the baseline prior art, receives a threaded baffle. Use of the axle 76 with such a door allows retrofit of existing freezers.

The axle 76 is concentrically received within the beater/scrapper assembly (53 of FIG. 2). A nozzle/cap 95 (FIG. 1) may be secured to the body at the outlet 82. For example, there may be snap-fit engagement with an outwardly open channel of an outlet boss 96 (FIG. 3A). The cap may have an interior surface of a cross-section selected to provide a desired extrusion profile (e.g., a star-shaped cross-section or a fluted cross-section). When present, the downstream rim of the cap may alternatively be regarded as forming an outlet.

FIG. 4 shows the lever rotated downward into an open/dispensing condition wherein a flow 520 may pass from the inlet to the outlet.

FIG. 3 shows the freezing cylinder 52 as comprising an inner wall 120 extending from a forward end closed by the door to a rear end closed by a domed end 122. The exemplary domed end 122 comprises an inlet 124 for receiving product via a conduit 126 (e.g., from the hopper 42 or from a pump or other source).

The freezing cylinder 52 includes an outer wall 130 with a space between the inner wall and the outer wall defining a heat exchanger (e.g., the heat rejection heat exchanger (evaporator) of the vapor compression refrigeration system 50).

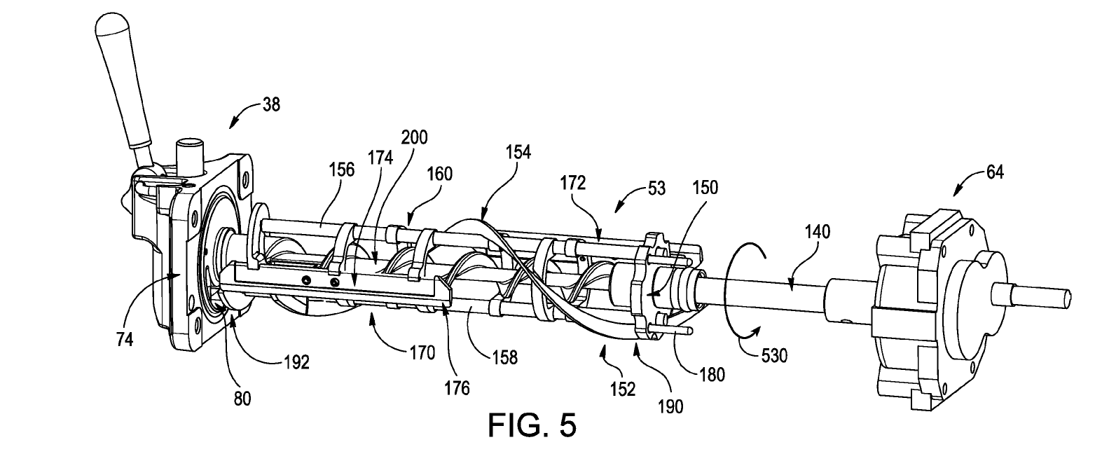

The beater/scraper assembly 53 comprises a drive shaft 140 extending through the domed end 122 and coupled to the transmission 64 and motor to drive rotation of the beater assembly. In conventional manner, the shaft 146 is keyed to engage a rear end plate 150 of the beater/scraper assembly (FIG. 5). An outer helical beater/scraper assembly 152 is mounted to the plate 150 extending forward therefrom. The assembly 152 comprises an outer helical member 154 supported by longitudinally-extending struts 156 and 158. The struts 156 and 158 are held to each other by a series of clamps 160. Some of these clamps 160 may mount the outer helical member 152. For example, the struts and clamps may form a frame integral to the outer helical member. Some of these clamps 160 may also mount one or more wiper assemblies 170, 172. In this example, there are two wiper assemblies diametrically offset from each other for balance and axially offset so as to provide full axial coverage. The wiper assemblies each comprise a wiper frame 174 removably mounting a longitudinal wiper blade 176 for wiping the inner diameter (ID) surface of the inner sidewall 120.

One or more stirring rods 180 may extend from the aft face of the plate 150 to maintain movement of material adjacent the freezing cylinder inlet 124.

The outer helical member 152 is generally helical/spiral with a first sense of direction and extending from a rear/upstream end 190 to a forward/downstream end 192. When rotated in a first direction 530 about the freezing cylinder axis 502, the outer helical member 152 drives product forward (flow 540) within the freezing cylinder. When the valve 38 is open, the outer helical member will drive product through the valve inlet port 80 and thus out the valve outlet port 82. The exemplary helix angle of the outer helical member may progressively change from end to end. In this example, the helix is relatively shallower near the forward end and relatively steeper (more nearly longitudinal) near the rear end.

The beater assembly also includes an inner helical member or screw 200. The exemplary inner helical member is non-metallic (e.g., polyoxymethylene or other acetal homopolymer or other engineering thermoplastic).

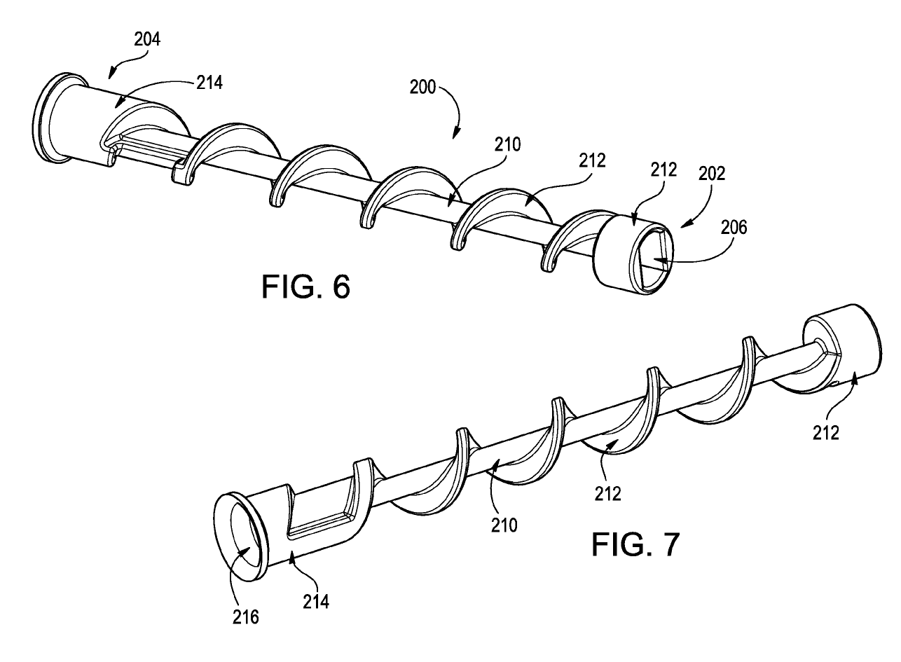

FIG. 6 shows the inner helical member extending from a rear end 202 to a forward end 204. The exemplary rear end 202 comprises an internal socket 206 that acts as a keying feature receiving a complementary end portion 208 (FIG. 3) of the shaft 140 to drive rotation along with the outer helical member as a unit. The exemplary inner helical member 200 comprises a unitarily molded combination of a central shaft 210 and a helical blade portion 212 wrapping the shaft and extending between a rear end portion 212 bearing the compartment 206 and a forward end portion 214 forming a cup having a compartment 216 (FIG. 7) rotatingly receiving the rear end portion of the boss 76. The inner helical member (i.e., its blade portion) is of opposite sense spiral to the helix of the outer helical member (i.e., if one corresponds to a left handed thread, the other corresponds to a right handed thread). When the beater/wiper assembly is rotated in the first direction 530 about the axis 502, the inner helical member 200 drives product rearward (flow 542) thus cooperating with the outer helical member 190 to provide a recirculation. The recirculation helps maintain product consistency during longer intervals between each dispensing.

Manufacturing methods and materials may otherwise be the same as those of any baseline system. Similarly, use parameters of the baseline system may otherwise be the same. A notable addition is the molding of the inner helical member 200 (e.g., injection molding).

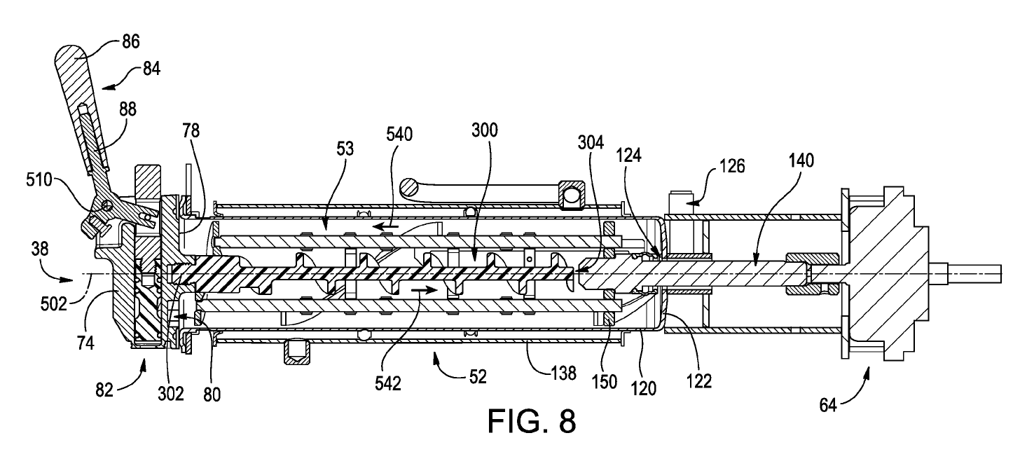

An alternative less ambitious reengineering/remanufacturing of a baseline unit involves replacing the fixed baffle of the baseline unit with a fixed inner helical member 300 (FIG. 8, e.g., of opposite sense to the outer helical member). The surfaces of the blade portion of the inner helical member may help drive product rearward via a pumping action driven by the outer helical member. The exemplary member 300 has a threaded end portion 302 that threads directly into the rear door boss of the baseline door. An opposite rear end 304 of the member 300 may be a free end (shown) or may be in rotationally sliding relation with a fixed member (not shown) or an end of a shaft rotating with the outer member. Otherwise, geometry and manufacture may be as noted above for the inner helical member 200.

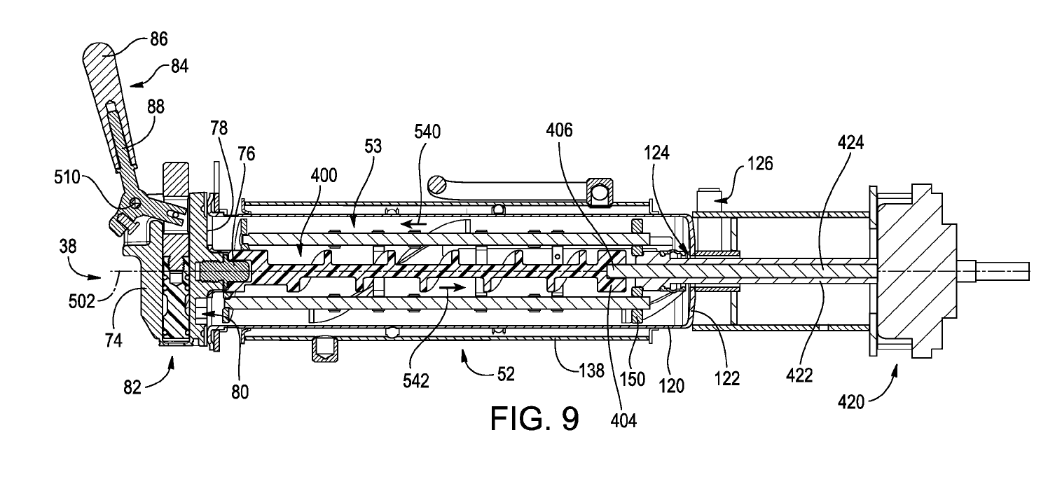

An alternative more ambitious reengineering/remanufacturing would involve providing a transmission or other arrangement for counterrotation of the inner helical member 400 (FIG. 9) and the outer helical member. In such a situation, the inner helical member and outer helical member would be of like sense to each other. This may be provided by configuring the transmission (gearbox) 420 with concentric counter-rotating output shafts 422 (driving the outer helical member) and 424 (driving the inner helical member). In this example, the inner helical member 400 forward end may be as noted for the member 200. The aft end 404 may have keyed interfitting with the forward end of the inner shaft (e.g., a faceted compartment in the end 404 receiving a complementary faceted end 406 of the shaft).

Although an embodiment is described above in detail, such description is not intended for limiting the scope of the present disclosure. It will be understood that various modifications may be made without departing from the spirit and scope of the disclosure. For example, when implemented in the engineering of an existing system configuration or the remanufacturing of an existing system, details of the existing system or configuration may influence or dictate details of the particular implementation. Accordingly, other embodiments are within the scope of the following claims.

1. A frozen product dispensing apparatus (20) comprising:
a refrigeration system (50);
a freezing cylinder (52);
a source (42) of the product or precursors of the product coupled to an inlet (124) of the freezing cylinder;
an outlet valve (38) having an open condition for discharging product from the freezing cylinder;
a beater assembly (53) and having:
an axis (502); and
an outer helical member (152) within the freezing cylinder; and
a motor (62) coupled to the beater assembly for driving rotation of the beater assembly about the axis so that when driving said rotation in a first direction (530), the outer helical member drives product (540) toward the outlet valve,
wherein:
the beater further comprises:
an inner helical member (200; 300; 400) within the outer helical member.

2. The apparatus of claim 1 wherein:
the inner helical member (200; 300) has a spiral opposite to the outer helical member.

3. The apparatus of claim 2 wherein:
the inner helical member (200) is mounted to rotate as a unit with the outer helical member.

4. The apparatus of claim 1 wherein:
the inner helical member (400) has a spiral in the same direction as the outer helical member; and
the inner helical member is mounted to rotate opposite to rotation of the outer helical member.

5. The apparatus of claim 1 wherein:
the inner helical member (300) is mounted to remain stationary in operation.

6. The apparatus of claim 1 wherein:
the outer helical member has a helix angle decreasing from a rear end toward a front end.

7. The apparatus of claim 1 wherein:
the outer helical member is a blade integral to a frame (156, 158, 160, 174) having features for removably mounting wiper blades (176).

8. The apparatus of claim 1 wherein:
the inner helical member (200; 400) has a blade (212) integral to a shaft (210) and an open cup (214) at one end.

9. The apparatus of claim 8 wherein:
the inner helical member, shaft, and open cup are a unitary non-metallic piece.

10. The apparatus of claim 1 wherein:
the outlet valve comprises an outlet valve body; and
an axle has a first portion in threaded engagement with the outlet valve body and a second portion received in a compartment of the inner helical member.

11. The apparatus claim 1 wherein:
the beater assembly axis is within 10° of horizontal in a normal operational condition.

12. The apparatus of claim 1 wherein the outlet valve comprises:
an inlet (80);
an outlet (82); and
a valve element shiftable between:
a first condition providing communication between the inlet and the outlet; and
a second condition blocking communication between the inlet and the outlet.

13. The apparatus of claim 1 further comprising:
an actuator (74) coupled to the valve element and manually engagable by a user to shift the valve element between the first condition and the second condition.

14. The apparatus of claim 13 wherein:
the actuator comprises a lever (74), the lever being shiftable from a neutral condition to respective first and second lever conditions to, respectively, shift the valve element to the valve element's first and second conditions.

15. The apparatus of claim 1 further comprising:
a cabinet (22) having a front (24), wherein the source is within the cabinet and the valve is mounted on the front.

16. The apparatus of claim 1 in combination with the confectionary product, the confectionary product being a frozen confectionary product.

17. A method for operating the apparatus of claim 1, the method comprising:
running the motor to drive said rotation in said first direction so that the outer helical member drives the product (540) toward the outlet valve and the inner helical member drives product away from the outlet valve.

18. The method of claim 17 further comprising:
opening the outlet valve from a closed condition to the open condition so as to discharge product from the freezing cylinder.

19. The apparatus of claim 7 further comprising:
wiper blades mounted to the features and positioned for wiping an inner diameter (ID) surface of a wall of the freezing cylinder.

20. A frozen product dispensing apparatus (20) comprising:
a refrigeration system (50);
a freezing cylinder (52);
a source (42) of the product or precursors of the product coupled to an inlet (124) of the freezing cylinder;
an outlet valve (38) having an open condition for discharging product from the freezing cylinder;
a beater assembly (53) within the freezing cylinder and having:
an axis (502); and
an outer helical member (152); and
a motor (62) coupled to the beater assembly for driving rotation of the beater assembly about the axis so that when driving said rotation in a first direction (530), the outer helical member drives product (540) toward the outlet valve,
wherein:
the beater further comprises:
an inner helical member (200; 300; 400) within the outer helical member; and
the outer helical member is a blade integral to a frame (156, 158, 160, 174) having features for removably mounting wiper blades (176).
